(19) United States
(12) Patent Application Publication
(10) Pub. No.: US 2015/0128041 A1
(43) Pub. Date: May 7, 2015

(54) Devices and Methods for Displaying Interface Elements of Media Players

(71) Applicant: Tencent Technology (Shenzhen) Company Limited, Shenzhen (CN)

(72) Inventor: Zhifeng Li, Shenzhen (CN)

(21) Appl. No.: 14/597,295

(22) Filed: Jan. 15, 2015

Related U.S. Application Data
(63) Continuation of application No. PCT/CN2014/084208, filed on Aug. 12, 2014.

(30) Foreign Application Priority Data
Oct. 16, 2013 (CN) 201310485323.X

(51) Int. Cl. G06F 3/0481; G06F 3/0482; G06F 3/0484

(52) U.S. Cl. CPC G06F 3/04812; G06F 3/04842; G06F 3/0482
USPC 715/716

(57) ABSTRACT

Devices and methods are provided for displaying interface elements of a player. For example, whether an interface cursor moves is detected; a detection result is generated; in response to the detection result indicating that the interface cursor moves, a starting time of a movement of the interface cursor and one or more starting coordinates of the interface cursor are recorded; one or more time points associated with the movement and one or more first coordinates of the interface cursor are recorded at one or more predetermined time intervals starting from the starting time; a data record is generated based on at least information associated with the starting time, the starting coordinates, the time points and the first coordinates; whether the movement satisfies one or more predetermined conditions is determined based on at least information associated with the data record to generate a determination result; and one or more interface elements of a player are displayed based on at least information associated with the determination result.

### CROSS-REFERENCES TO RELATED APPLICATIONS

The application claims priority to Chinese Patent Application No. 201310485323.X, filed Oct. 16, 2013, incorporated by reference herein for all purposes.

### BACKGROUND OF THE INVENTION

Certain embodiments of the present invention are directed to computer technology. More particularly, some embodiments of the invention provide systems and methods for displaying interface elements. Merely by way of example, some embodiments of the invention have been applied to media players. But it would be recognized that the invention has a much broader range of applicability.

Usually, a user watches a video (e.g., movies, TV shows, etc.) using user equipment (e.g., a desktop computer, a laptop computer, etc.). For example, a media player is used to open a video file for playing. In another example, a video file is played through a web page opened in a browser. When a video file on a network is played on the web page, a related player plug-in is often called. When the user equipment plays the video file in full screen, if a mouse moves (e.g., a corresponding interface cursor movement), the media player or the player plug-in displays a related interface element (e.g., a top menu, a play progress bar, a volume control button, etc.), so that the user conveniently controls the playing of the related video file.

The above-noted conventional technology has some disadvantages. For example, when a user equipment is placed on an unstable platform (e.g., an uneven tea table, a desktop of a moving train, etc.), a mouse of the user equipment is likely to move under the influence of the unstable platform. When the interface cursor moves to a relevant region on a screen, the media player or the player plug-in in a full screen display status displays a related interface element, which goes against the will of the user and disturbs the user watching the video.

Hence it is highly desirable to improve the techniques for displaying interface elements of media players.

### BRIEF SUMMARY OF THE INVENTION

According to one embodiment, a method is provided for displaying interface elements of a player. For example, whether an interface cursor moves is detected; a detection result is generated; in response to the detection result indicating that the interface cursor moves, a starting time of a movement of the interface cursor and one or more starting coordinates of the interface cursor are recorded; one or more time points associated with the movement and one or more first coordinates of the interface cursor are recorded at one or more predetermined time intervals starting from the starting time; a data record is generated based on at least information associated with the starting time, the starting coordinates, the time points and the first coordinates; whether the movement satisfies one or more predetermined conditions is determined based on at least information associated with the data record to generate a determination result; and one or more interface elements of a player are displayed based on at least information associated with the determination result.

According to another embodiment, a device for displaying interface elements of a player includes: a detection module configured to detect whether an interface cursor moves and generate a detection result; a record module configured to, in response to the detection result indicating that the interface cursor moves, record a starting time of a movement of the interface cursor and one or more starting coordinates of the interface cursor, record one or more time points associated with the movement and one or more first coordinates of the interface cursor at one or more predetermined time intervals starting from the starting time, and generate a data record based on at least information associated with the starting time, the starting coordinates, the time points and the first coordinates; a first determination module configured to determine whether the movement satisfies one or more predetermined conditions based on at least information associated with the data record to generate a determination result; and a display control module configured to display one or more interface elements of a player based on at least information associated with the determination result.

According to yet another embodiment, a non-transitory computer readable storage medium includes programming instructions for displaying interface elements of a player. The programming instructions are configured to cause one or more data processors to execute certain operations. For example, whether an interface cursor moves is detected; a detection result is generated; in response to the detection result indicating that the interface cursor moves, a starting time of a movement of the interface cursor and one or more starting coordinates of the interface cursor are recorded; one or more time points associated with the movement and one or more first coordinates of the interface cursor are recorded at one or more predetermined time intervals starting from the starting time; a data record is generated based on at least information associated with the starting time, the starting coordinates, the time points and the first coordinates; whether the movement satisfies one or more predetermined conditions is determined based on at least information associated with the data record to generate a determination result; and one or more interface elements of a player are displayed based on at least information associated with the determination result.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing user equipment for displaying interface elements of media players according to one embodiment of the present invention.

FIG. 2 is a simplified diagram showing a device for displaying interface elements of media players according to one embodiment of the present invention.

FIG. 3 is a simplified diagram showing a device for displaying interface elements of media players according to another embodiment of the present invention.

FIG. 4 is a simplified diagram showing a method for displaying interface elements of media players according to one embodiment of the present invention.

FIG. 5 is a simplified diagram showing a method for displaying interface elements of media players according to another embodiment of the present invention.

FIG. 6 is a simplified diagram showing a method for displaying interface elements of media players according to yet another embodiment of the present invention.

### DETAILED DESCRIPTION OF THE INVENTION

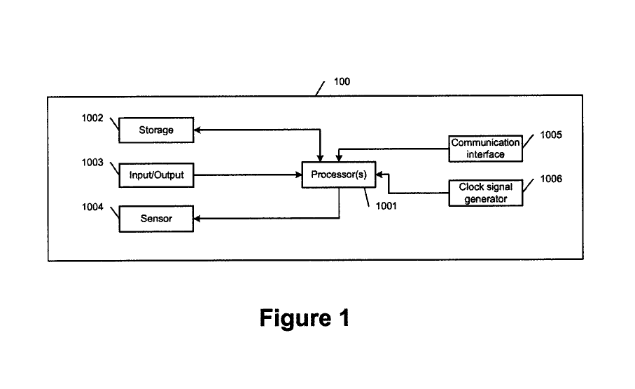

FIG. 1 is a simplified diagram showing user equipment for displaying interface elements of media players according to one embodiment of the present invention. The diagram is merely an example, which should not unduly limit the scope of the claims. One of ordinary skill in the art would recognize many variations, alternatives, and modifications. For example, the user equipment 100 includes a running environment and/or a working mode.

As shown in FIG. 1, the user equipment 100 is installed with a computer operating system, according to some embodiments. For example, the user equipment 100 includes a desktop computer, a laptop, a server, a system formed by a combination of a desktop computer, a laptop and/or a server, etc. As an example, the user equipment 100 includes one or more processors 1001, a storage 1002 (e.g., a memory device), a sensor 1004, a clock signal generator 1006, a communication interface 1005, input-output equipment 1003, etc. In another example, the user equipment 100 is configured to display interface elements of one or more media players.

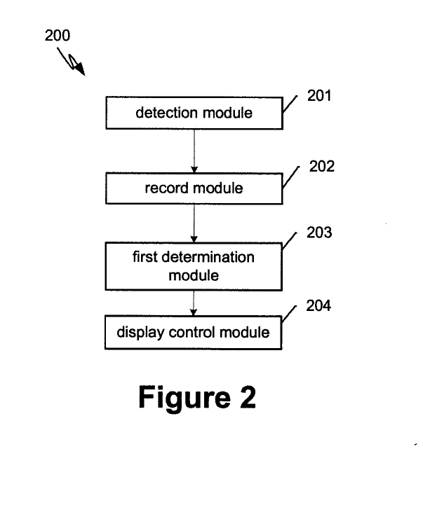

FIG. 2 is a simplified diagram showing a device for displaying interface elements of media players according to one embodiment of the present invention. The diagram is merely an example, which should not unduly limit the scope of the claims. One of ordinary skill in the art would recognize many variations, alternatives, and modifications.

According to one embodiment, the device 200 includes a detection module 201, a record module 202, a first determination module 203 and a display control module 204. For example, the detection module 201 is configured to detect whether an interface cursor moves and generate a detection result. As an example, the detection module 201 detects whether the interface cursor moves by calling an interface progress related to the interface cursor in a computer operating system. In another example, after the detection result is generated, the detection module 201 sends the detection result to the record module 202.

According to another embodiment, the record module 202 is configured to, in response to the detection result indicating that the interface cursor moves, record a starting time of a movement of the interface cursor and one or more starting coordinates of the interface cursor, record one or more time points associated with the movement and one or more first coordinates of the interface cursor every predetermined time interval starting from the starting time, and generate a data record based on at least information associated with the starting time, the starting coordinates, the time points and the first coordinates. For example, the predetermined time interval is a time period corresponding to 0.1 second, 0.2 second, etc. As an example, the record module 202 acquires the time points associated with the movement of the interface cursor and the first coordinates by calling the interface progress, related to the interface cursor, in the computer operating system. In another example, the data record includes time information (e.g., the time points) and coordinate information (e.g., the first coordinates), which are related to the movement action of the interface cursor. In yet another example, every time the coordinates of the interface cursor change, the record module 202 records the corresponding time point and the changed coordinates. For instance, when the coordinates of the interface cursor changes for the n^{th} time, the corresponding time point and coordinates are recorded as Tₙ and Pₙ.

According to yet another embodiment, the first determination module 203 is configured to determine whether the movement satisfies one or more predetermined conditions based on at least information associated with the data record to generate a determination result. For example, the first determination module 203 can calculate a trajectory corresponding to the movement action of the interface cursor according to the data record, then analyze characteristics of the trajectory and thus determine whether the movement action satisfies the predetermined conditions. As an example, the first determination module 203 determines whether the movement action of the interface cursor is a subjective movement of a corresponding user (e.g., the user moves a mouse actively so that the interface cursor moves) or an objective movement of the corresponding user (e.g., the user collides with a desktop or an external environment factor leads to the movement action so that the interface cursor moves beyond user's expectations) by analyzing data in the data record.

In one embodiment, the display control module 204 is configured to display one or more interface elements of a player based on at least information associated with the determination result. For example, the display control module 204 can be configured to determine whether a signal from the interface cursor is blocked according to the determination result. As an example, when a movement of the interface cursor, which is obtained through determination, is generated by the user moving the mouse actively, the display control module 204 either displays the player interface elements or does not block the signal of the interface cursor. On the other hand, when the movement of the interface cursor, which is obtained through determination, is not to user's expectations, the display control module 204 does not display the player interface elements. By utilizing the device 200, the interference of the interface cursor to the user caused by an external environment factor is avoided and image distortion in the process of watching a video can be avoided.

In another embodiment, the display control module 204 is configured not to display the interface elements when the determination result shows that the movement action satisfies the predetermined conditions. For example, the display control module 204 is configured to prevent (e.g., prohibit or stop) the player interface elements from being displayed, or intercept the player interface elements. In another example, the display control module 204 is also configured to display the player interface elements when the determination result shows that the movement action does not satisfy the predetermined conditions.

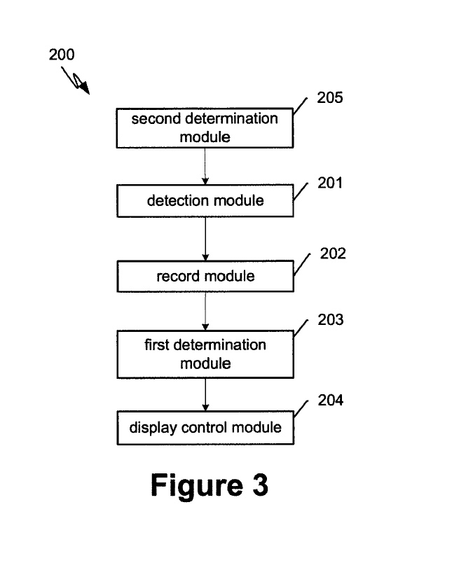

FIG. 3 is a simplified diagram showing a device for displaying interface elements of media players according to another embodiment of the present invention. The diagram is merely an example, which should not unduly limit the scope of the claims. One of ordinary skill in the art would recognize many variations, alternatives, and modifications.

In some embodiments, the device 200 further includes a second determination module 205 configured to determine whether a play interface of the player is in a full screen display status. For example, the detection module 201 is further configured to detect whether the interface cursor moves in response to the play interface being in the full screen display status. As an example, the predetermined conditions include two or more of a first predetermined condition, a second predetermined condition and a third predetermined condition.

In some embodiments, the first predetermined condition includes: the time points are located at a front stage (e.g., a first part) of a predetermined time interval, where the front stage (e.g., a first part) is associated with a first threshold in the predetermined time interval. For example, the collected time points are basically in the front of the range of the predetermined time interval, where the first threshold corresponds to any numerical value from 15% to 75%, such as 60%, 50%, 40%, 75%, 33%, etc.

In certain embodiments, the second predetermined condition includes: a trajectory associated with the changed coordinates corresponds to a straight status, where the straight status indicates that an angle formed by connecting three points on the trajectory is greater than or equal to a second threshold. For example, the angle is an obtuse angle and the second threshold is 160 degrees. The angle is greater than or equal to 160 degrees, which means that the trajectory is approximate to a straight line. In another example, the second threshold corresponds to any numerical value from 135 degrees to 179 degrees, such as 150 degrees, 155 degrees, 167 degrees, 170 degrees, 178 degrees, etc.

In some embodiments, the third predetermined condition includes: acceleration associated with the movement within the one or more predetermined time intervals is in a constant status. For example, the constant status indicates that a change rate of the acceleration associated with a particular time relative to an acceleration average is smaller than or equal to a third threshold within the predetermined time intervals. In another example, the third threshold corresponds to any numerical value from 1% to 15%, such as 3%, 4%, etc. In yet another example, the acceleration average corresponds to an average value of the acceleration associated with the movement within the one or more predetermined time intervals. As an example, the acceleration is approximately invariable.

In certain embodiments, if two of the three predetermined conditions are satisfied, it is determined that a vibration causes a mouse movement. For example, the display control module 204 is configured to block a signal of the interface cursor movement. In another example, the display control module 204 is configured not to block the signal of the interface cursor movement and to display the interface elements. The interface elements include one or more of: a menu bar, a play progress bar, a control panel, and an advertisement display area, according to some embodiments.

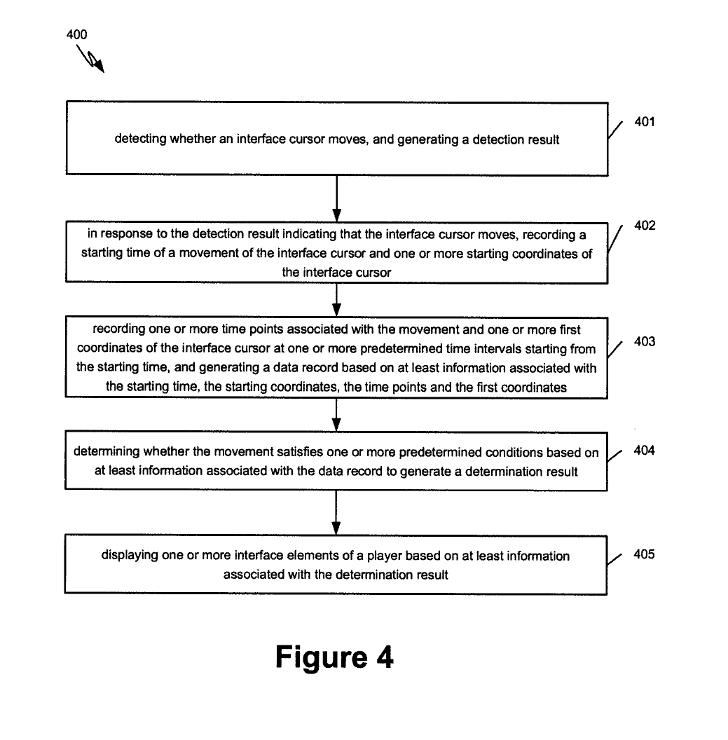

FIG. 4 is a simplified diagram showing a method for displaying interface elements of media players according to one embodiment of the present invention. The diagram is merely an example, which should not unduly limit the scope of the claims. One of ordinary skill in the art would recognize many variations, alternatives, and modifications. The method 400 includes at least processes 401-405.

According to one embodiment, during the process 401, a detection module 201 detects whether an interface cursor moves and generates a detection result. As an example, the detection module 201 detects whether the interface cursor moves by calling an interface progress related to the interface cursor in a computer operating system. In another example, after the detection result is generated, the detection module 201 sends the detection result to the record module 202.

According to another embodiment, during the process 402, the record module 202 records a starting time of a movement of the interface cursor and one or more starting coordinates of the interface cursor when the detection result shows that the interface cursor moves. For example, during the process 403, the record module 202 records time points corresponding to the occurrence of the movement action and changed coordinates of the interface cursor every predetermined time interval from the starting time, and generates a corresponding data record according to the time points corresponding to the occurrence of each movement action and the corresponding changed coordinates which are recorded at the starting time, the starting coordinates and every predetermined time interval. As an example, the predetermined time interval is a time period corresponding to 0.15 second. In another example, the predetermined time interval is a time period corresponding to 0.1 second, 0.2 second, etc. As an example, the record module 202 acquires the time points associated with the movement of the interface cursor and the first coordinates by calling the interface progress, related to the interface cursor, in the computer operating system. In another example, the data record includes time information (e.g., the time points) and coordinate information (e.g., the first coordinates), which are related to the movement action of the interface cursor. In yet another example, every time the coordinates of the interface cursor change, the record module 202 records the corresponding time point and the changed coordinates. For instance, when the coordinates of the interface cursor changes for the n^{th} time, the corresponding time point and coordinates are recorded as Tₙ and Pₙ.

According to yet another embodiment, during the process 404, the first determination module 203 determines whether the movement satisfies one or more predetermined conditions based on at least information associated with the data record to generate a determination result. For example, the first determination module 203 can calculate a trajectory corresponding to the movement action of the interface cursor according to the data record, then analyze characteristics of the trajectory and thus determine whether the movement action satisfies the predetermined conditions. As an example, the first determination module 203 determines whether the movement action of the interface cursor is a subjective movement of a corresponding user (e.g., the user moves a mouse actively so that the interface cursor moves) or an objective movement of the corresponding user (e.g., the user collides with a desktop or an external environment factor leads to the movement action so that the interface cursor moves beyond user's expectations) by analyzing data in the data record.

In one embodiment, during the process 405, the display control module 204 displays one or more interface elements of a player based on at least information associated with the determination result. For example, the display control module 204 can be configured to determine whether a signal from the interface cursor is blocked according to the determination result. As an example, when a movement of the interface cursor, which is obtained through determination, is generated by the user moving the mouse actively, the display control module 204 either displays the player interface elements or does not block the signal of the interface cursor. On the other hand, when the movement of the interface cursor, which is obtained through determination, is not to user's expectations, the display control module 204 does not display the player interface elements. By implementing the method 400, the interference of the interface cursor to the user caused by an external environment factor is avoided and image distortion in the process of watching a video can be avoided.

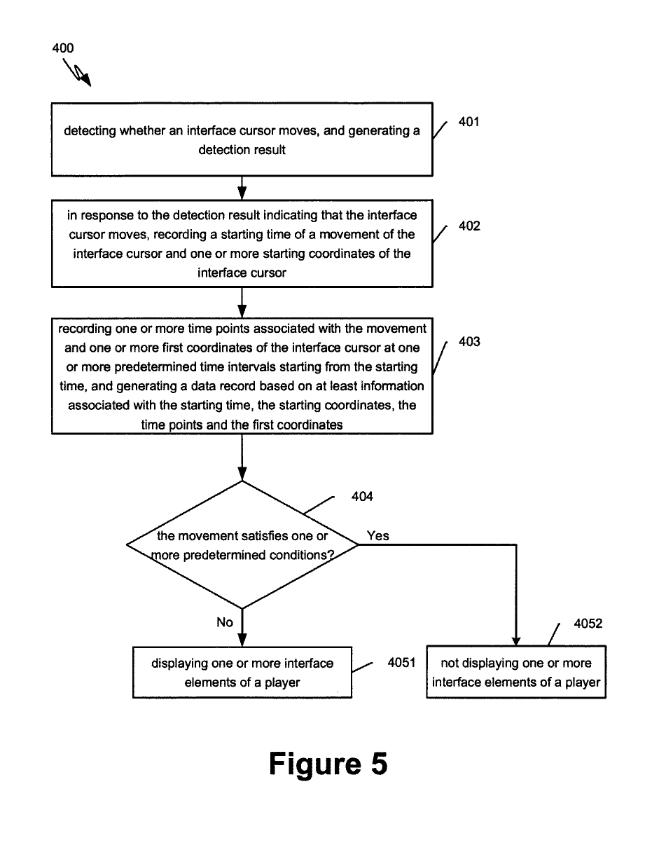

FIG. 5 is a simplified diagram showing a method for displaying interface elements of media players according to another embodiment of the present invention. The diagram is merely an example, which should not unduly limit the scope of the claims. One of ordinary skill in the art would recognize many variations, alternatives, and modifications.

According to one embodiment, the process 405 includes at least sub-processes 4051 and 4052. For example, during the sub-process 4051, the display control module 204 displays the interface elements when the determination result shows that the movement action satisfies the predetermined conditions. In another example, during the sub-process 4052, the display control module 204 does not display the interface elements when the determination result shows that the movement action satisfies the predetermined conditions. For example, the display control module 204 prevents (e.g., prohibit or stop) the player interface elements from being displayed, or intercept the player interface elements.

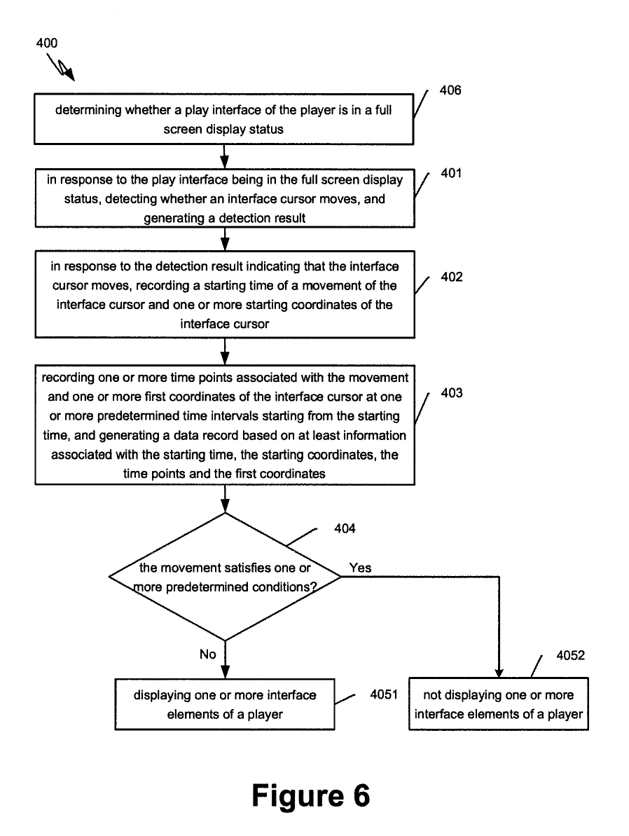

FIG. 6 is a simplified diagram showing a method for displaying interface elements of media players according to yet another embodiment of the present invention. The diagram is merely an example, which should not unduly limit the scope of the claims. One of ordinary skill in the art would recognize many variations, alternatives, and modifications.

According to some embodiments, the method 400 further includes a process 601, during which the second determination module 205 determines whether a play interface of a player is in a full screen display status. For example, the detection module 201 detects whether the interface cursor moves in response to the play interface being in the full screen display status. As an example, the predetermined conditions include two or more of: a first predetermined condition, a second predetermined condition and a third predetermined condition.

In some embodiments, the first predetermined condition includes: the time points are located at a front stage (e.g., a first part) of a predetermined time interval, where the front stage (e.g., a first part) is associated with a first threshold in the predetermined time interval. For example, the collected time points are basically in the front of the range of the predetermined time interval, where the first threshold corresponds to any numerical value from 15% to 75%, such as 60%, 50%, 40%, 75%, 33%, etc.

In certain embodiments, the second predetermined condition includes: a trajectory associated with the changed coordinates corresponds to a straight status, where the straight status indicates that an angle formed by connecting three points on the trajectory is greater than or equal to a second threshold. For example, the angle is an obtuse angle and the second threshold is 160 degrees. The angle is greater than or equal to 160 degrees, which means that the trajectory is approximate to a straight line. In another example, the second threshold corresponds to any numerical value from 135 degrees to 179 degrees, such as 150 degrees, 155 degrees, 167 degrees, 170 degrees, 178 degrees, etc.

In some embodiments, the third predetermined condition includes: acceleration associated with the movement within the one or more predetermined time intervals is in a constant status. For example, the constant status indicates that a change rate of the acceleration associated with a particular time relative to an acceleration average is smaller than or equal to a third threshold within the predetermined time intervals. In another example, the third threshold corresponds to any numerical value from 1% to 15%, such as 3%, 4%, etc. In yet another example, the acceleration average corresponds to an average value of the acceleration associated with the movement within the one or more predetermined time intervals. As an example, the acceleration is approximately invariable.

In certain embodiments, if two of the three predetermined conditions are satisfied, it is determined that a vibration causes a mouse movement. For example, the display control module 204 blocks a signal of the interface cursor movement. In another example, the display control module 204 does not block the signal of the interface cursor movement and to display the interface elements. The interface elements include one or more of: a menu bar, a play progress bar, a control panel, and an advertisement display area, according to some embodiments.

In some embodiments, “interface cursor” includes a cursor displayed on a user interface in a computer operating system and can be expressed as a mouse cursor in general language. In certain embodiments, “player interface elements” or “interface elements” include part of or all of blocks in the user interface of a media player program, where the blocks are configured to display corresponding pictures, icons, animations, etc., where the player program is configured to play a video file, an audio file, etc.

According to one embodiment, a method is provided for displaying interface elements of a player. For example, whether an interface cursor moves is detected; a detection result is generated; in response to the detection result indicating that the interface cursor moves, a starting time of a movement of the interface cursor and one or more starting coordinates of the interface cursor are recorded; one or more time points associated with the movement and one or more first coordinates of the interface cursor are recorded at one or more predetermined time intervals starting from the starting time; a data record is generated based on at least information associated with the starting time, the starting coordinates, the time points and the first coordinates; whether the movement satisfies one or more predetermined conditions is determined based on at least information associated with the data record to generate a determination result; and one or more interface elements of a player are displayed based on at least information associated with the determination result. For example, the method is implemented according to at least FIG. 4, FIG. 5, and/or FIG. 6.

According to another embodiment, a device for displaying interface elements of a player includes: a detection module configured to detect whether an interface cursor moves and generate a detection result; a record module configured to, in response to the detection result indicating that the interface cursor moves, record a starting time of a movement of the interface cursor and one or more starting coordinates of the interface cursor, record one or more time points associated with the movement and one or more first coordinates of the interface cursor at one or more predetermined time intervals starting from the starting time, and generate a data record based on at least information associated with the starting time, the starting coordinates, the time points and the first coordinates; a first determination module configured to determine whether the movement satisfies one or more predetermined conditions based on at least information associated with the data record to generate a determination result; and a display control module configured to display one or more interface elements of a player based on at least information associated with the determination result. For example, the device is implemented according to at least FIG. 1, FIG. 2, and/or FIG. 3.

According to yet another embodiment, a non-transitory computer readable storage medium includes programming instructions for displaying interface elements of a player. The programming instructions are configured to cause one or more data processors to execute certain operations. For example, whether an interface cursor moves is detected; a detection result is generated; in response to the detection result indicating that the interface cursor moves, a starting time of a movement of the interface cursor and one or more starting coordinates of the interface cursor are recorded; one or more time points associated with the movement and one or more first coordinates of the interface cursor are recorded at one or more predetermined time intervals starting from the starting time; a data record is generated based on at least information associated with the starting time, the starting coordinates, the time points and the first coordinates; whether the movement satisfies one or more predetermined conditions is determined based on at least information associated with the data record to generate a determination result; and one or more interface elements of a player are displayed based on at least information associated with the determination result. For example, the storage medium is implemented according to at least FIG. 4, FIG. 5, and/or FIG. 6.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for displaying interface elements of a player, the method comprising:
detecting whether an interface cursor moves;
generating a detection result;
in response to the detection result indicating that the interface cursor moves, recording a starting time of a movement of the interface cursor and one or more starting coordinates of the interface cursor;
recording one or more time points associated with the movement and one or more first coordinates of the interface cursor at one or more predetermined time intervals starting from the starting time;
generating a data record based on at least information associated with the starting time, the starting coordinates, the time points and the first coordinates;
determining whether the movement satisfies one or more predetermined conditions based on at least information associated with the data record to generate a determination result; and
displaying one or more interface elements of a player based on at least information associated with the determination result.

2. The method of claim 1, wherein the displaying interface elements of a player based on at least information associated with the determination result includes:
in response to the movement satisfying the predetermined conditions, not displaying the interface elements of the player; and
in response to the movement not satisfying the predetermined conditions, displaying the interface elements of the player.

3. The method of claim 1, wherein the predetermined conditions include two or more of: a first predetermined condition, a second predetermined condition and a third predetermined condition.

4. The method of claim 3, wherein:
the first predetermined condition includes: the time points are located at a first part of the predetermined time intervals; and
the first part corresponds to a first threshold related to the predetermined time intervals.

5. The method of claim 3, wherein:
the second predetermined condition includes: a trajectory associated with the changed coordinates corresponds to a straight status; and
the straight status indicates that an angle formed by connecting three points on the trajectory is greater than or equal to a second threshold.

6. The method of claim 3, wherein:
the third predetermined condition includes: acceleration associated with the movement within the one or more predetermined time intervals is in a constant status;
the constant status indicates that a change rate of the acceleration associated with a particular time relative to an acceleration average is smaller than or equal to a third threshold within the predetermined time intervals; and
the acceleration average corresponds to an average value of the acceleration associated with the movement within the one or more predetermined time intervals.

7. The method of claim 1, further comprising:
determining whether a play interface of the player is in a full screen display status;
wherein the detecting whether an interface cursor moves includes: detecting whether the interface cursor moves in response to the play interface being in the full screen display status.

8. The method of claim 1, wherein the interface elements include one or more of: a menu bar, a play progress bar, a control panel, and an advertisement display area.

9. A device for displaying interface elements of a player, the device comprising:
a detection module configured to detect whether an interface cursor moves and generate a detection result;
a record module configured to, in response to the detection result indicating that the interface cursor moves, record a starting time of a movement of the interface cursor and one or more starting coordinates of the interface cursor, record one or more time points associated with the movement and one or more first coordinates of the interface cursor at one or more predetermined time intervals starting from the starting time, and generate a data record based on at least information associated with the starting time, the starting coordinates, the time points and the first coordinates;
a first determination module configured to determine whether the movement satisfies one or more predetermined conditions based on at least information associated with the data record to generate a determination result; and
a display control module configured to display one or more interface elements of a player based on at least information associated with the determination result.

10. The device of claim 9, wherein the display control module is configured to:
in response to the movement satisfying the predetermined conditions, not display the interface elements of the player; and
in response to the movement not satisfying the predetermined conditions, display the interface elements of the player.

11. The device of claim 9, wherein the predetermined conditions include two or more of: a first predetermined condition, a second predetermined condition and a third predetermined condition.

12. The device of claim 11, wherein;
the first predetermined condition includes: the time points are located at a first part of the predetermined time intervals; and
the first part corresponds to a first threshold related to the predetermined time intervals.

13. The device of claim 11, wherein:
the second predetermined condition includes: a trajectory associated with the changed coordinates corresponds to a straight status; and
the straight status indicates that an angle formed by connecting three points on the trajectory is greater than or equal to a second threshold.

14. The device of claim 11, wherein:
the third predetermined condition includes: acceleration associated with the movement within the one or more predetermined time intervals is in a constant status;
the constant status indicates that a change rate of the acceleration associated with a particular time relative to an acceleration average is smaller than or equal to a third threshold within the predetermined time intervals; and
the acceleration average corresponds to an average value of the acceleration associated with the movement within the one or more predetermined time intervals.

15. The device of claim 9, further comprising:
a second determination module configured to determine whether a play interface of the player is in a full screen display status;
wherein the detection module is further configured to detect whether the interface cursor moves in response to the play interface being in the full screen display status.

16. The device of claim 9, wherein the interface elements include one or more of: a menu bar, a play progress bar, a control panel, and an advertisement display area.

17. The device of claim 9, further comprising:
one or more data processors; and
a computer-readable storage medium;
wherein one or more of the detection module, the record module, the first determination module and the display control module are stored in the storage medium and configured to be executed by the one or more data processors.

18. A non-transitory computer readable storage medium comprising programming instructions for displaying interface elements of a player, the programming instructions configured to cause one or more data processors to execute operations comprising:
detecting whether an interface cursor moves;
generating a detection result;
in response to the detection result indicating that the interface cursor moves, recording a starting time of a movement of the interface cursor and one or more starting coordinates of the interface cursor;
recording one or more time points associated with the movement and one or more first coordinates of the interface cursor at one or more predetermined time intervals starting from the starting time;
generating a data record based on at least information associated with the starting time, the starting coordinates, the time points and the first coordinates;
determining whether the movement satisfies one or more predetermined conditions based on at least information associated with the data record to generate a determination result; and
displaying one or more interface elements of a player based on at least information associated with the determination result.
